(19) United States
(12) Patent Application Publication
(10) Pub. No.: US 2012/0247351 A1
(43) Pub. Date: Oct. 4, 2012

(54) METAL CAN KRUSHING DEVICE

(76) Inventor: Alfonza Steadman, SR., Akron, OH (US)

(21) Appl. No.: 13/079,421

(22) Filed: Apr. 4, 2011

(51) Int. Cl. B30B 9/32; B30B 1/00

(52) U.S. Cl. 100/257; 100/280; 100/270

(57) ABSTRACT

The present invention is a metal can crushing device that includes a plurality of gears, a handle that is integral to the gears, a casing to house the gears, an accommodating open area with a top planar surface and a bottom planar surface that horizontally extend from the casing to receive a can to be crushed, the top planar surface is integral to the gears and controlled by the handle to exert pressure and crush the can and a spring housed within the top planar surface to stretch or condense the accommodating open area to accommodate different sized the cans. The metal can crushing device can also utilize a push button and hydraulic, pneumatic or electric gears.

### TECHNICAL FIELD & BACKGROUND

Recycling cans is not only beneficial for the environment but it can also be a lucrative supplemental income for the recycler if done in large quantities. Currently there are limited alternatives to manual methods of crushing cans that avoid the hassles of excessive time consumption, inefficiency, and bulky cans that waste space.

The present invention generally relates to a metal crushing device. More specifically, the invention is a metal can crushing device.

It is an object of the invention to provide a metal can crushing device to simplify the process of crushing cans.

It is an object of the invention to provide a metal can crushing device that can either stretch or condense to accommodate different sized cans.

It is an object of the invention to provide a metal can crushing device that facilitates recycling and generating income from selling crushed cans.

What is really needed is a metal can crushing device to simplify the process of crushing cans that can either stretch or condense to accommodate different sized cans and that facilitates recycling and generating income from selling metal crushed cans.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a side perspective view of a metal can crushing device, in accordance with one embodiment of the present invention.

FIG. 2A illustrates a side perspective view of a metal can crushing device, in accordance with one embodiment of the present invention.

FIG. 2B illustrates a side perspective view of a metal can crushing device with a crushed metal can, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

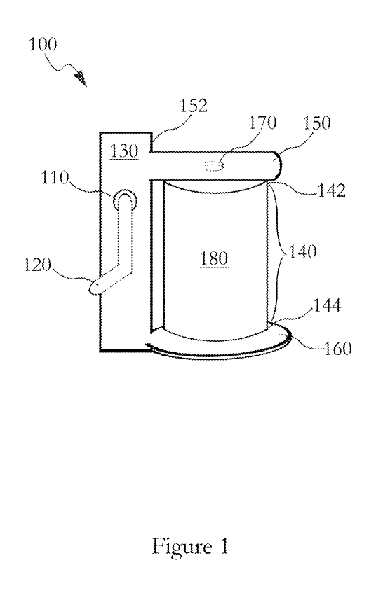

FIG. 1 illustrates a side perspective view of a metal can crushing device 100, in accordance with one embodiment of the present invention. The metal can crushing device 100 includes a plurality of gears 110, a handle 120, a casing 130, an accommodating open area 140 with a top planar surface 150 with a clearing surface 152 and a bottom planar surface 160, a spring 170 and a can 180.

The gears 110 can be any number and type of gears that are utilized to exert pressure on top of can 170 to be crushed. Gears 110 are wound by turning handle 120 that are integral to the gears 110. The casing 130 internally houses the gears 110 and provides an accommodating open area 140. The accommodating open area 140 accommodates a can 170 to be crushed. The top planar surface 150 extends horizontally from the casing 130 to form the top 142 of the accommodating open area 140 and exerts pressure on the can 180 to crush the can 180. The top planar surface 140 is controlled by the handle 120 and gears 110. The clearing surface 152 allows the top planar surface 150 to move upwards and clear a can 180 that is to be removed or placed under the top planar surface 150. The bottom planar surface 160 extends horizontally from the casing 130 to form the bottom 144 of the accommodating open area 140. The spring 170 is internally housed in the top planar surface 140 and stretches or condenses the accommodating open area 140 to accommodate different sized cans. The can 180 is a metal can, aluminum can or other suitable type of can.

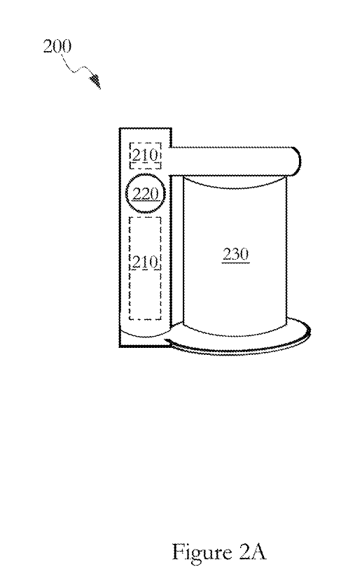

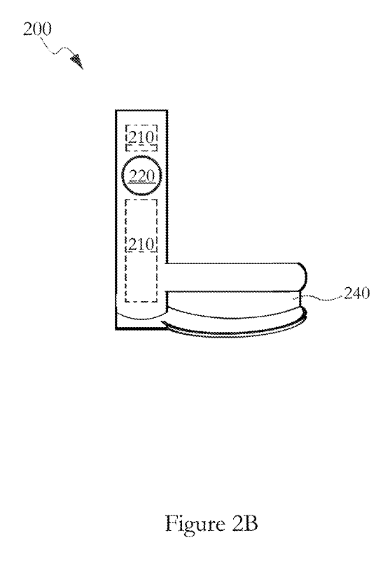

FIG. 2A illustrates a side perspective view of a metal can crushing device 200, in accordance with one embodiment of the present invention. The metal can crushing device 200 has the same components as the metal can crushing device 100 described in FIG. 1, except for the hydraulic, pneumatic or electric gears 210 utilized instead of the generic gears 110 utilized in FIG. 1. A push button 220 that is integral to the hydraulic, pneumatic or electric gears 210 exerts pressure to crush the can 230 in one complete motion or an incremental motion. In one embodiment, the push button 220 can be depressed once to fully activate the hydraulic, pneumatic or electric gears 210. In another embodiment, the push button 220 can be required to be continuously depressed while crushing the can 230. The push button 220 can also partially crush any amount of the can 230 as well, such as half the can, a quarter of the can or ¾ths of the can.

FIG. 2B illustrates a side perspective view of a metal can crushing device 200 with a crushed can 240, in accordance with one embodiment of the present invention. The metal can crushing device 200 has the same components as the metal can crushing device 100 described in FIG. 1, except for the hydraulic, pneumatic or electric gears 210 utilized instead of the generic gears 110 utilized in FIG. 1. As previously indicated, the push button 220 can be required to be continuously depressed while crushing the can 230 or can also partially crush any amount of the can 230 as well. The metal can crushing device 200 illustrated in FIG. 2B has fully crushed a metal can 230.

The metal can crushing device is a handheld appliance that is utilized to crush metal or aluminum cans in approximately under one minute, thereby significantly reducing the time spent crushing cans. When using the metal can crushing device, the can is placed between the top planar surface and the bottom planar surface of the device and the handle is turned or button is depressed, which rapidly crushes the can due to pressure from the internal winding gears. The metal can crushing device maximizes the recycling storage space and can be used at sporting events, tail gates, barbecues, and other outdoor events which typically generate an excess of aluminum or steel cans.

The metal can crushing device can effectively crush cans of varying sizes due to the spring contained within the appliance, allowing for stretching or condensing according to the size of the can. The metal can crushing device is available in an assortment of colors and designs to complement or enhance existing home decor. The metal can crushing device is approximately 12 inches long where the handle is connected to the casing and gears and approximately 9 inches in width where the handle connects into the casing and gears. The bottom planar surface and top planar surface are approximately 1 inch thick and 3 to 4 inches wide and are rounded at the distal ends. The casing and handle is made of plastic or metal or other suitable material.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A metal can crushing device, comprising:
a plurality of gears;
a handle that is integral to said gears to turn said gears;
a casing to house said gears;
an accommodating open area with a top planar surface and a bottom planar surface that horizontally extend from said casing to receive a can to be crushed, said top planar surface is integral to said gears and controlled by said handle to exert pressure and crush said can; and
a spring housed within said top planar surface to stretch or condense said accommodating open area to accommodate different sized said cans.

2. The device according to claim 1, wherein said can is made of aluminum or steel.

3. The device according to claim 1, wherein said device is made of plastic or metal.

4. The device according to claim 1, wherein said device is approximately 12 inches long where said handle is connected to said casing and gears.

5. The device according to claim 1, wherein said device is approximately 9 inches in width where said handle is connected to said casing and gears.

6. A metal can crushing device made of metal, comprising:
a plurality of gears;
a handle that is integral to said gears to turn said gears;
a casing to house said gears;
an accommodating open area with a top planar surface and a bottom planar surface that horizontally extend from said casing to receive an aluminum can to be crushed, said top planar surface is integral to said gears and controlled by said handle to exert pressure and crush said aluminum can; and
a spring housed within said top planar surface to stretch or condense said accommodating open area to accommodate different sized said cans.

7. The device according to claim 6, wherein said casing and said handle are made of plastic or metal.

8. The device according to claim 6, wherein said can is made of steel.

9. The device according to claim 6, wherein said bottom planar surface and said top planar surface are approximately 1 inch thick and 3 to 4 inches wide.

10. The device according to claim 9, wherein said bottom planar surface and said top planar surface are rounded at a distal end.

11. The device according to claim 6, wherein said device is made of plastic,

12. The device according to claim 6, wherein sad device is approximately 12 inches long where said handle is connected to said casing and gears.

13. The device according to claim 6, wherein said device is approximately 9 inches in width where said handle is connected to said casing and gears.

14. A metal can crushing device, comprising:
a plurality of hydraulic, pneumatic or electric gears;
a push button that is integral to said gears to turn said gears to activate crushing a can;
a casing to house sad gears;
an accommodating open area with a top planar surface and a bottom planar surface that horizontally extend from said casing to receive said can to be crushed, said top planar surface is integral to said gears and controlled by said button to exert pressure and crush said can; and
a spring housed within said top planar surface to stretch or condense said accommodating open area.

15. The device according to claim 14, wherein said button is depressed once to fully activate said gears.

16. The device according to claim 14, wherein said button is continuously depressed to crush said can.

17. The device according to claim 14, wherein said button can partially crush said can any amount.

18. The device according to claim 14, wherein said can is made of aluminum or steel.

19. The device according to claim 14, wherein said device is made of plastic or metal.

20. The device according to claim 14, wherein said device is approximately 12 inches long and approximately 9 inches in width where said handle is connected to said casing and gears.
